(19) United States
(12) Patent Application Publication
(10) Pub. No.: US 2022/0000250 A1
(43) Pub. Date: Jan. 6, 2022

(54) CLIP ON MOLDABLE BEAR SPRAY CANISTER HOLSTER WITH ADJUSTABLE RETENTION

(71) Applicant: Benjamin Alan Bolt, Kalispell, MT (US)

(72) Inventor: Benjamin Alan Bolt, Kalispell, MT (US)

(21) Appl. No.: 17/366,009

(22) Filed: Jul. 1, 2021

Related U.S. Application Data
(60) Provisional application No. 63/048,081, filed on Jul. 4, 2020.

(51) Int. Cl. A45F 5/00; B29C 67/00; B29C 53/04

(52) U.S. Cl. CPC A45F 5/00; B29C 2793/0081; B29C 53/04; B29C 67/0011

(57) ABSTRACT

In the world of bear spray, options for holsters are almost nonexistent. Manufactures of bear sprays offer holsters that are designed to be inexpensive, and mass produced. Most of these holsters require the use of a belt, something a lot of people are not wearing while they are hiking, hunting, or camping. The current options available completely lack versatility to the users preferred attire and are of a disposable nature. I felt that if a product as wonderful as bear spray is to work to save humans and bears lives it must be able to be carried in a comfortable user-friendly holster that has different attachment options that will work with the attire that the user is going to be wearing. It needed to be in a holster that retains and protects the canister and allows for lightning fast draws in dangerous situations. I worked hard to create a holster that is high quality, durable, and aids to assist preform the task of quickly deploying bear spray in high stress, emergency situations. Holsters are as much of the protection system as the canister of bear spray itself.

### CROSS REFERENCE TO RELATED APPLICATIONS

This application claims the benefit of U.S. Provisional Application No. 63/048,081, filed on Jul. 4, 2020, which is fully incorporated by reference in its entirety to provide continuity of disclosure.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The invention described herein relates to the fields of self-defense, and personal protective equipment where conflicts with animals are a possibility. The present invention is constructed of moldable plastic material such as Kydex®. Such material is rigid, adjustable, and is capable of being clipped on to a belt, pack, or anywhere else with accommodating connection means. The preferred embodiment of the present invention allows a user to quicky and easily holster their bear spray canister and attach it to their person or gear. The present invention allows a user to be able to rapidly draw a bear spray canister to defend themselves against a bear or other animal attack in a self-defense situation. The adjustable retention system of the present invention allows a user to adjust the retention level of the holster to meet the users' preferences and needs. The present invention can come in various sizes depending on the bear spray canister size. The present invention can come with various types of clips and methods of attachment.

Various examples of bear spray canister holsters exist in the prior art. The most common is a cloth type, which is stretchable and requires a belt be worn to attach the holster and canister to their person. This style of holster also uses a strap to retain the canister in the holster. This strap must be removed from over the canister prior to being able to draw the canister from the holster. This method of retention slows the draw speed of the canister, which could prove quite dangerous in situations of close fast animal attacks, especially surprise encounters. A plastic injection type holster exists in the prior art; however, its design and function is completely different to that of present invention. This style is designed with flexible sides to achieve the holster's retention. The retention system used by this type of holster is not adjustable. The design of this type of injection molded holster is such to form a clip-on type of attachment that is not changeable and is completely different in nature to that of the present invention.

Due to issues discussed above, there is a need for an improved, more rugged, customizable, adjustable, easy to clip-on, bear spray canister holster. One object of the present invention is to create a bear spray holster that is customizable. The invention described herein allows the user to attach the holster to their body with multiple attachment options. The holster can be used with the standard FOMI clip or any number of different clips or attachments for clothing, packs, straps, or any other option user deems best for themselves. Another object of the present invention is to create a design this is adjustable to different canister sizes. The tensioning system of the present invention makes this a possibility. Users can carry their bear spray brand of choice in a holster that they can adjust to their perfect amount of draw resistance and cannister retention. Being able to adjust the draw resistance and canister retention of the described holster allows users the opportunity to carry bear spray during many more activities where other holster styles would lose retention of a spray canister. Finally, another object of present invention is to create a rugged holster that is built to last a lifetime and not disposable like the other options on the market.

### BRIEF SUMMARY OF THE INVENTION

The subject invention solves the problems outlined above. The preferred embodiment of the subject invention is a holster to be used with a bear deterrent spray canister. The body of the subject invention is constructed with a moldable plastic material commonly such as Kydex®. This plastic material is heated and formed into a shape that is the correct size to accommodate a bear spray canister within. When the moldable plastic material body cools it regains its very rigid character. This material was chosen because of its ability to be extremely durable, very rigid, and maintenance free. The subject invention utilizes screws and binder posts to attach a separate clip that may vary in nature. This ability to mount various types of attachments to the holster body makes this the most versatile holster made. The subject invention is a holster that accommodates various size bear spray canisters allowing it to be used with any size bear spray canister on the market. The subject invention utilizes a special tensioning system that allows easy adjustment of the amount of draw resistance and canister retention that is placed on the bear spray canister while the canister is inserted in the holster. This ability to adjust the draw resistance and canister retention allows the user to set the amount of force it takes to pull the canister from the holster. The subject invention's retention system allows the user to increase or decrease the amount of retention of the canister depending on the type of activity being done while using this invention. The design of the subject invention is the next evolution in bear spray holsters. Taking bear spray holsters to a higher performance level for the safety of users against animal attacks that are a common threat.

### BRIEF DESCRIPTION OF THE DRAWINGS

FIG. 1 is an elevated perspective view showing top, first side, and back of a preferred embodiment of the invention. Drawing shows a holster body, FOMI clip, and overlap of moldable plastic material to form back of holster.

FIG. 2 is a back view of holster. Drawing shows hole locations for the four Chicago screws. Two Chicago screws near top of holster for clip or other attachment. Two Chicago screws near bottom for retention system.

FIG. 3 is a front view of holster.

FIG. 4 is low perspective view showing bottom, side, and back of holster. Drawing shows retaining tab in bottom of opening.

FIG. 5 is a first side view of holster.

FIG. 6 is a second side view of holster.

FIG. 7 is a first side perspective exploded view of two Chicago screws used to secure top of holster body and clip. It also shows the two Chicago screws securing bottom of holster body making up adjustable retention system.

FIG. 8 is a top view of holster.

FIG. 9 is a bottom view of holster.

FIG. 10 is an exploded top view of top two Chicago screws and clip.

FIG. 11 is an exploded bottom view of bottom two Chicago screws and rubber tension washers.

FIG. 12 is a cut a way view of the retention system with rubber tension washers fully compressed.

FIG. 13 is a cut away view of the retention system with the rubber tension washers fully expanded.

FIG. 14 is an exploded cut a way view of the retention system. Drawing shows two bottom Chicago screws and rubber tension washers.

FIG. 15 is a drawing of the general shape the moldable plastic material piece is cut to before being formed into body of holster. Drawing shows the tab extending down from body piece.

FIG. 16 is an elevated perspective view of the design of the form used to form the body of the holster.

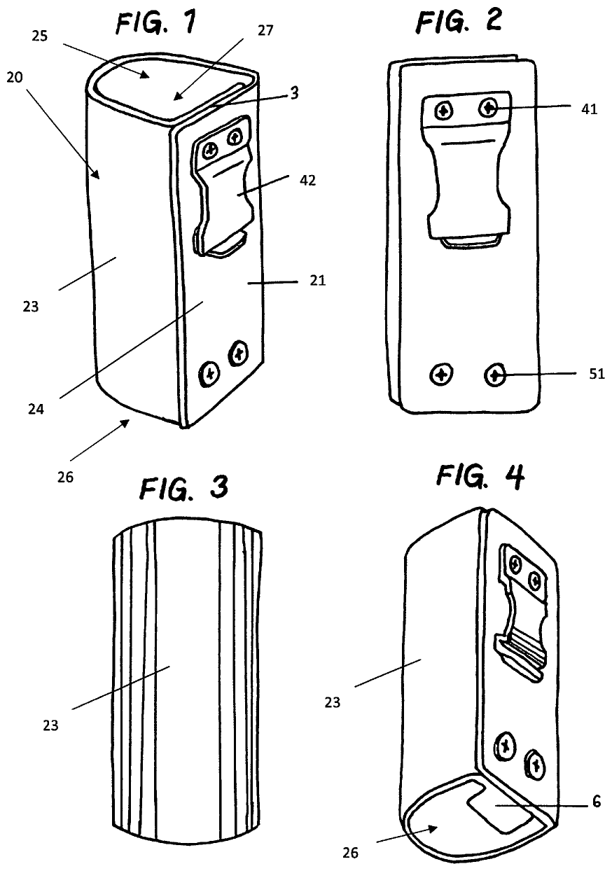

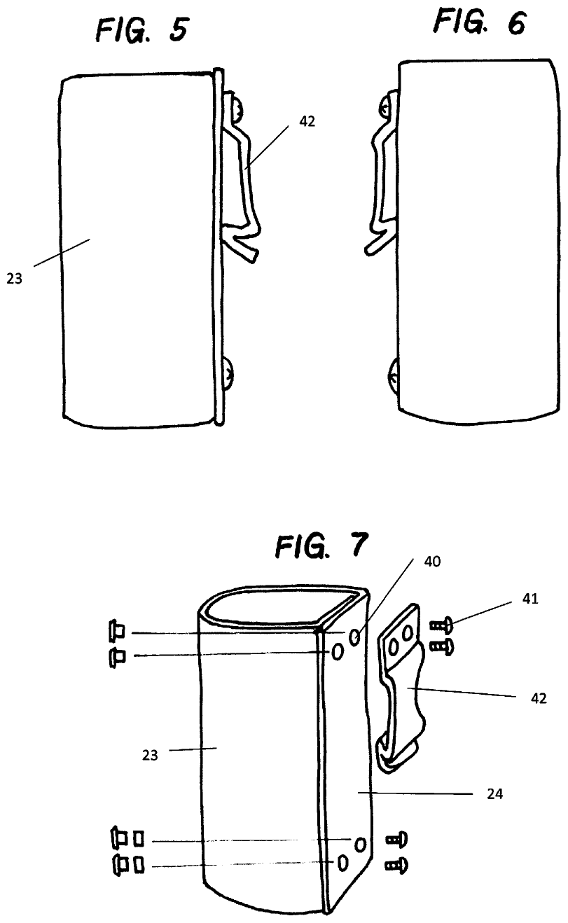

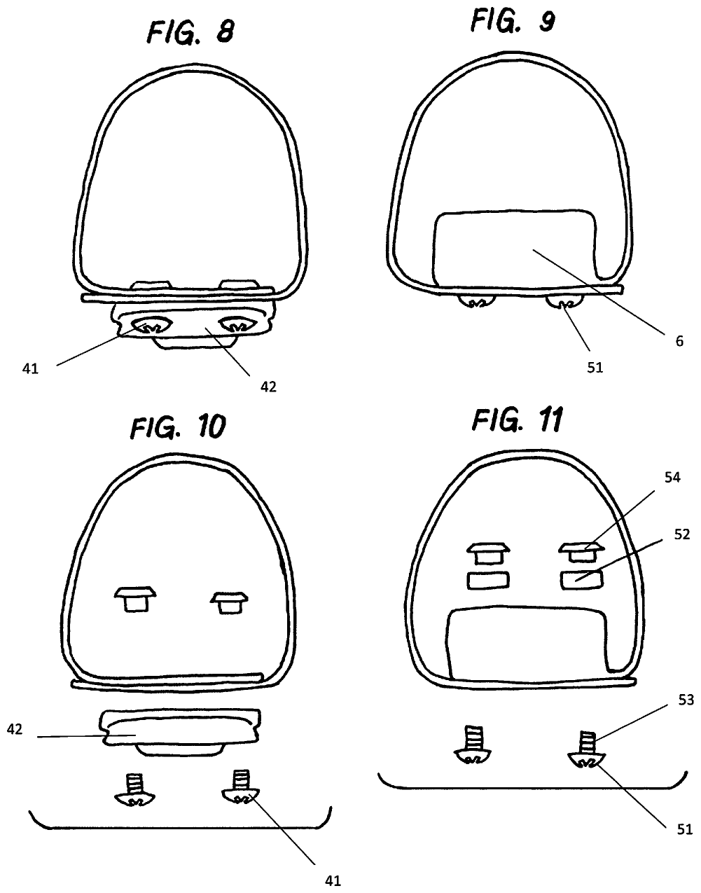

### DETAILED DESCRIPTION OF THE INVENTION

Although only one embodiment of the invention is explained in detail, the figures and explanations should be understood as illustrations only and are not intended to limit the invention in its scope. Also, in describing the embodiment, specific terminology may be used, but it should be understood that specific terms include all technical equivalents that operate in similar manners to accomplish similar purposes.

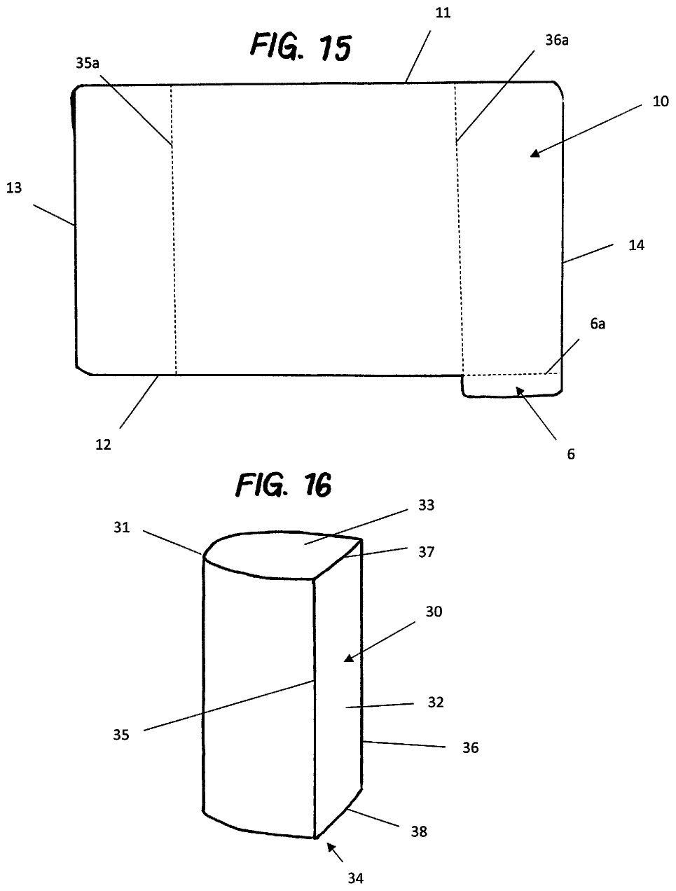

With reference to the drawings, the preferred embodiment of subject invention, is illustrated. The preferred embodiment of the invention is depicted in FIG. 1. The preferred embodiment of the subject invention is a holster 20 designed to carry commonly used bear deterrent spray canisters of various manufacturers and various sizes. The subject invention is manufactured by first cutting a piece of moldable plastic material 10 such as Kydex® into the general shape depicted in FIG. 15. The general shape of the cut material is comprised of a first longitudinal side 11, a second longitudinal side 12 which is further comprised of a protruding tab 6, a first end 13, and a second end 14, which comprises a portion of said tab 6. Said cut piece of moldable plastic material 10 comprises the body 21 of the holster 20. The size of the cut piece of moldable plastic material 10 for the body 21 can be varied depending on the size of the bear spray canister it is being made to accommodate. The shape of the cut piece of moldable plastic material 10 for the holster 20 body 21 can be varied depending on preferred positioning of a canister in relation to a preferred attachment point of the holster 20 to the user or other article of attachment.

The body 21 of said holster is generally comprised of a vertically disposed, cylindrical side wall 23, connected to a vertically disposed flat back wall 24, wherein said cylindrical side wall 23 and vertically disposed flat back wall 24 enclose a space 27 which accommodates said cannister. Said body 21 is further comprised of a top open end 25, a bottom open end 26, wherein said bottom open end is further comprised of said tab 6, which supports said canister.

In FIG. 4 the tab 6 of said piece of moldable plastic material 10 is shown post formation. Said tab comprises a bottom shelf for said bear spray canister to sit on, and said tab 6 prevents said canister from protruding out the bottom of said holster 20.

To form the holster 20 body 21, the piece of moldable plastic material 10 is warmed until it is uniformly pliable and formable in its entirety. The warmed and pliable piece of moldable plastic material 10 is then wrapped around a premade form 30, shown in FIG. 16. Said form 30 can be made to accommodate cannisters of different sizes and shapes. The preferred embodiment of the form 30 is comprised of first cylindrical side wall 31, a second flat sidewall 32, a top end 33, and a bottom end 34, which opposes said top end 33. Said second flat sidewall 32 is generally rectangular in shape and is comprised of a first longitudinal edge 35, a second longitudinal edge 36, a top edge 37, and a bottom edge 38.

Said warmed and pliable piece of moldable plastic material 10 is wrapped around the form 30 in the following sequence: (1) A fold line 6a of said tab 6 is lined up with said bottom edge 38 of said form 30 second flat sidewall 32 while said moldable plastic material 10 is pressed flat on the surface of said second flat sidewall 32. (2) Said moldable plastic material 10 is then folded over said second longitudinal edge 36 at an approximate fold line 36a. (3) Said moldable plastic material 10 is then wrapped around said first cylindrical side wall 31. (4) Said moldable plastic material 10 is then folded over said first longitudinal edge 35 of said form 30 at approximate fold line 35a so moldable plastic material 10 overlaps 3 the first flat section of material pressed flat on the surface of said second flat sidewall 32. (5) Once said moldable plastic material 10 is tightly wrapped around said form 30, said tab is 6 is folded at fold line 6a so that said tab 6 is pressed flat against the surface of said bottom end 34 of said form 30. Once formed, said tab 6 is located on the inside of the overlapping flat portions of the holster 20 body 21. (6) The formed holster 20 body 21 is held in the formed position until said moldable plastic material 10 cools and becomes rigid. Once the formed holster 20 body 21 has cooled and becomes rigid, said form 30 is then slid out from inside the newly formed rigid body 21 of the holster 20.

Once the holster 20, body 21 is formed, a plurality of holes 40 are then drilled in the vertically disposed flat back wall 24 of the holster body 21 to accommodate a connection means between said holster 20, body 21 and an attachment means utilized to attach the holster 20 to a user or other article. One familiar with the art would recognize that many connection means would be suitable for said connection. In the preferred embodiment, a plurality of multipurpose Chicago screws 41 secure the formed holster 20 body 21 and secure a FOMI clip 42 or other preferred attachment to the upper portion of the holster 20 body 21.

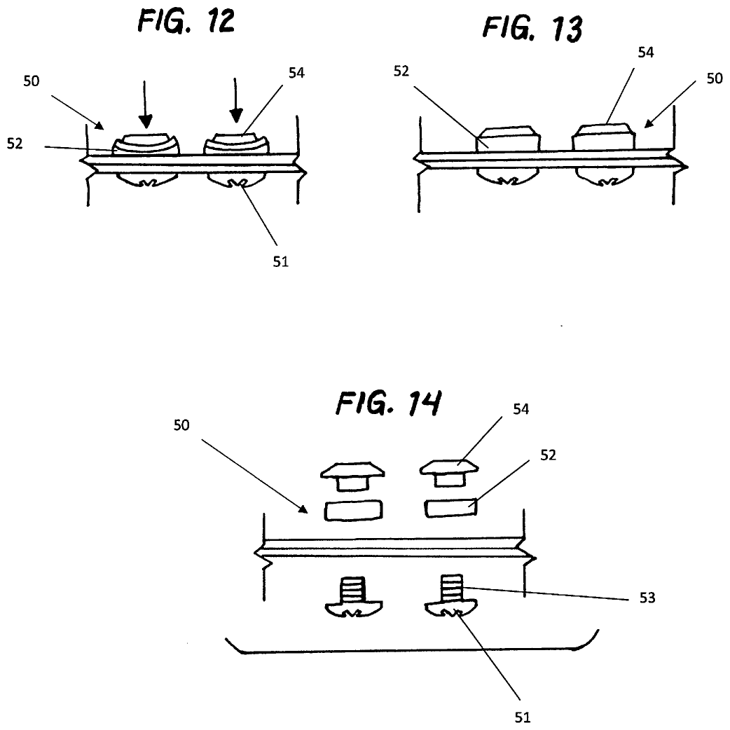

The holster 20 is further comprised of an adjustable retention system 50, which allows a user to easily adjust the amount of draw resistance and cannister retention that is placed on the canister while the canister is inserted in the holster 20. Said retention system is comprised of a plurality of multipurpose Chicago screws 51, wherein said screws secure the bottom portion of the holster 20 body 21 and comprise the retention system 50. The retention system 50 is designed to be adjustable. The retention system 50 is further comprised of a plurality of rubber tension washers 52, which correspond to each Chicago screw 51. Said rubber tension washers 52 are installed on the threaded portion 53 of each Chicago screw 51 in the interior space 27 of the holster 20 body 21. The rubber tension washers 52 are secured by a post 54, which is comprised of corresponding threads to the threaded portion 53 of each Chicago screw 51. Retention is adjusted by tightening or loosening said Chicago screws 51, which compresses or expands the rubber tension washers 52. Retention force against an inserted cannister is decreased by tightening said Chicago screws 51, which compresses said rubber tension washers 52 as shown in FIG. 12. Retention force against an inserted cannister is increased by loosening said Chicago screws 51, which allows expansion of said rubber tension washers 52 as shown in FIG. 13.

After assembling the top portion of the holster body with clip 42 and corresponding Chicago screws 41 and assembling bottom portion of holster body with retention system 50, the preferred canister is inserted into holster and draw tension can be adjusted to a desired level.

It is understood that the foregoing examples are merely illustrative of the present invention. Certain modifications of the articles and/or methods may be made and still achieve the objectives of the invention. Such modifications are contemplated as within the scope of the claimed invention.

What is claimed is:

1. A clip-on moldable canister holster with adjustable retention comprising:
a body, wherein said body is comprised of a vertically disposed, cylindrical side wall, connected to a vertically disposed flat back wall,
wherein said cylindrical side wall and vertically disposed flat back wall enclose a space which accommodates a canister,
wherein said body is further comprised of a top open end, a bottom open end, wherein said bottom open end is further comprised of a tab, which supports said cannister.

2. The clip-on moldable canister holster with adjustable retention of claim 1 wherein said body is comprised of a moldable plastic material.

3. The clip-on moldable canister holster with adjustable retention of claim 2 wherein said moldable plastic material is comprised of Kydex®.

4. The clip-on moldable canister holster with adjustable retention of claim 1 further comprising a plurality of holes drilled in said vertically disposed flat back wall of said holster body, which accommodate a connection means between said holster body and an attachment means utilized to attach said holster to a user or other article.

5. The clip-on moldable canister holster with adjustable retention of claim 4 wherein said connection means is comprised of plurality of multipurpose Chicago screws.

6. The clip-on moldable canister holster with adjustable retention of claim 5 wherein said attachment means is comprised of a FOMI clip.

7. The clip-on moldable canister holster with adjustable retention of claim 1 wherein said holster is further comprised of an adjustable retention system, which allows a user to adjust an amount of draw resistance exerted on a cannister inserted within said holster.

8. The clip-on moldable canister holster with adjustable retention of claim 7 wherein said retention system is comprised of a plurality of multipurpose Chicago screws, wherein said screws secure the bottom portion of said holster.

9. The clip-on moldable canister holster with adjustable retention of claim 8 wherein said retention system is further comprised of a plurality of rubber tension washers installed on a threaded portion of each Chicago screw, wherein said rubber tension washers are secured by a post, which is comprised of corresponding threads to the threaded portion of each Chicago screw.

10. The clip-on moldable canister holster with adjustable retention of claim 9, wherein draw resistance is adjusted by tightening or loosening said Chicago screws, which compresses or expands said rubber tension washers.

11. The clip-on moldable canister holster with adjustable retention of claim 9 further comprising a form, wherein said form is comprised of a first cylindrical side wall, a second flat sidewall, a top end, and a bottom end, which opposes said top end, wherein said second flat sidewall is rectangular in shape and is comprised of a first longitudinal edge, an opposing second longitudinal edge, a top edge, and a bottom edge.

12. A method of manufacturing a clip-on moldable canister holster with adjustable retention comprising the following steps:
A. cutting a piece of moldable plastic material, wherein the general shape of said cut material is comprised of a first longitudinal side, a second longitudinal side which is further comprised of a protruding tab, a first end, and a second end, which comprises a portion of said tab.
B. warming said piece of moldable plastic material until said material is uniformly pliable; and
C. wrapping said moldable plastic material in the following sequence:
(1) lining up a fold line of said tab with a bottom edge of a form flat sidewall while pressing said moldable plastic material on the surface of said flat sidewall;
(2) folding said moldable plastic material over a second longitudinal edge of said form at an approximate fold line;
(3) wrapping said moldable plastic material around a first cylindrical side wall of said form;
(4) folding said moldable plastic material over a first longitudinal edge of said form at an approximate fold line so said moldable plastic material overlaps the first flat section of material initially pressed flat on the surface of said flat sidewall;
(5) folding said tab at said fold line so that said tab is pressed flat against a bottom surface of said form;
(6) Holding said formed holster body until said moldable plastic material cools and becomes rigid.
